(19) United States
(12) Patent Application Publication
(10) Pub. No.: US 2005/0040954 A1
(43) Pub. Date: Feb. 24, 2005

(54) Pressure sensitive doorbell mat

(76) Inventor: Terry C. McNally, Port Angeles, WA (US)

Correspondence Address: Jacques M. Dulin, Eaq.;Innovation Law Group, Ltd., Suite 201, NetPort Center, Sequim, WA, 98382-3338, US

(21) Appl. No.: 10/643,317

(22) Filed: Aug. 19, 2003

(51) Int. Cl. G08B 23/00

(52) U.S. Cl. 340/573.3; 340/666

(57) ABSTRACT

A pressure sensitive apparatus includes a mat and a speaker box. The mat has a first contact plate, a second contact plate, and a compression spring positioned between the first and second contact plates thereby creating a space between the first and second contact plates. The speaker box includes a speaker and a power source connected to the speaker. The pressure sensitive apparatus further includes a connecting means for connecting the power source to the speaker through the mat. Upon applying a pre-determined amount of pressure on the mat, a bias force of the compression spring is overcome and compresses the compression spring thereby causing the first contact plate and the second contact plate to contact one another completing an electrical circuit between the power source and the speaker and causing an audible sound to be emitted from the speaker.

### FIELD OF THE INVENTION

The present invention relates generally to doorbells for pets and, more specifically, to a pressure sensitive apparatus that reacts to the weight of a dog or a cat walking thereon by transmitting a signal to a remote device inside the house causing an audio clip of a dog barking or a cat meowing to be audibilized to inform the owner that the pet is at the door.

### BACKGROUND

Numerous other types of door alert systems for pets exist in the prior art. Typical of these are U.S. Pat. Nos. 2,742,674; 1,776,992; 2,783,327; 4,323,883; 4,551,713; 4,780,706; 4,924,214; 5,604,478; 5,952,926; 6,094,139; and 6,445,302. While these pet doorbell devices maybe suitable for the purposes for which they were designed, they would not be as suitable for the purposes of the present invention, as hereinafter described.

### THE INVENTION

### SUMMARY, INCLUDING OBJECTS AND ADVANTAGES

The present invention relates generally to doorbells for pets and, more specifically, to a pressure sensitive apparatus that reacts to the weight of a dog or a cat walking thereon by transmitting a signal to a remote device inside the house causing an audio clip of a dog barking or a cat meowing to be audibilized to inform the owner that the pet is at the door.

A primary object of the present invention is to provide a pressure sensitive apparatus for pets that activates a remote doorbell for generating a tone sequence.

Another object of the present invention is to provide a pressure sensitive apparatus for pets to inform occupants within a dwelling that a pet is waiting outside the door to come inside.

Yet another object of the present invention is to provide a pressure sensitive apparatus for pets including a ringing device which emulates the sound of a dog barking or a cat meowing when it is sensed a pet is positioned on the apparatus.

Another object of the present invention is to provide a pressure sensitive apparatus for pets wherein the apparatus is connected to a doorbell by either a wired or wireless connection.

Still another object of the present invention is to provide a pressure sensitive apparatus for pets that will allow the user to record the sound of their own pet to bark or meow to provide a personalized tone sequence rather than a generic audio clip.

Another object of the present invention is to provide a pressure sensitive apparatus for pets having a plurality of pre-recorded messages allowing the user to change the tone sequence.

Still another object of the present invention is to provide a pressure sensitive apparatus for pets providing a plurality of methods for the user to customize the tone or message generated by the doorbell.

Yet another object of the present invention is to provide a pressure sensitive apparatus for pets that is simple and easy to use.

Still yet another object of the present invention is to provide a pressure sensitive apparatus with doorbell for pets that is inexpensive to manufacture and operate.

Additional objects of the present invention will appear as the description proceeds. The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS FIGURES

In order that the invention may be more fully understood, it will now be described, by way of example, with reference to the accompanying drawing in which:

FIG. 1 is an illustrative view of the pressure sensitive apparatus of the present invention in use outside of a house;

FIG. 2 is an illustrative view of the pressure sensitive apparatus of the present invention in use inside of a house;

FIG. 3 is an illustrative view of the pressure sensitive apparatus of the present invention with a pet positioned thereon;

FIG. 4 is a perspective view of the pressure sensitive apparatus of the present invention having a hardwire connection between the mat and the speaker box;

FIG. 5 is a cross-sectional view of the pressure sensitive apparatus of the present invention shown in an uncompressed and inactive state taken along line 5-5 in FIG. 4;

FIG. 6 is a sectional view of the pressure sensitive apparatus of the present invention shown in a compressed and active state;

FIG. 7 is a perspective view of the pressure sensitive apparatus of the present invention showing a wireless connection between the mat and the speaker box;

FIG. 8 is a cross-sectional view of the speaker box of the present invention taken along line 8-8 in FIG. 4;

FIG. 9 is a cross-sectional view of the speaker box of the present invention taken along line 9-9 in FIG. 7;

FIG. 10 is a front view of the speaker box of the present invention;

FIG. 11 is a block diagram of the tone sequencer and memory of the present invention;

FIG. 12 is an electrical diagram of the present invention having a hardwired connection between the mat and the speaker box; and

FIG. 13 is an electrical diagram of the present invention having a wireless connection between the mat and the speaker box.

### DETAILED DESCRIPTION OF THE PREFERRED EMBODIMENT

The following discussion describes in detail one embodiment of the present invention. This discussion should not be construed, however, as limiting the invention to those particular embodiments. Practitioners skilled in the art will recognize numerous other embodiments as well. For definition of the complete scope of the invention, the reader is directed to appended claims.

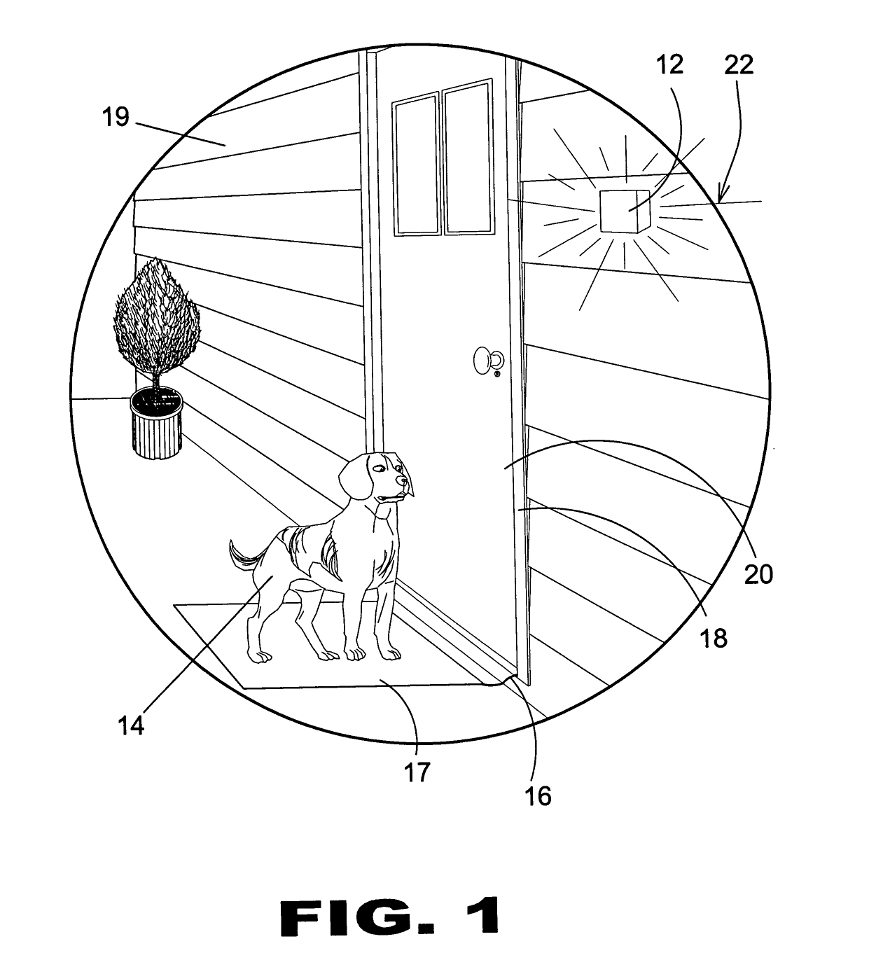

Turning now descriptively to the drawings, in which similar reference characters denote similar elements throughout the several views, FIGS. 1 through 13 illustrate a pressure sensitive apparatus of the present invention indicated generally by the numeral 10.

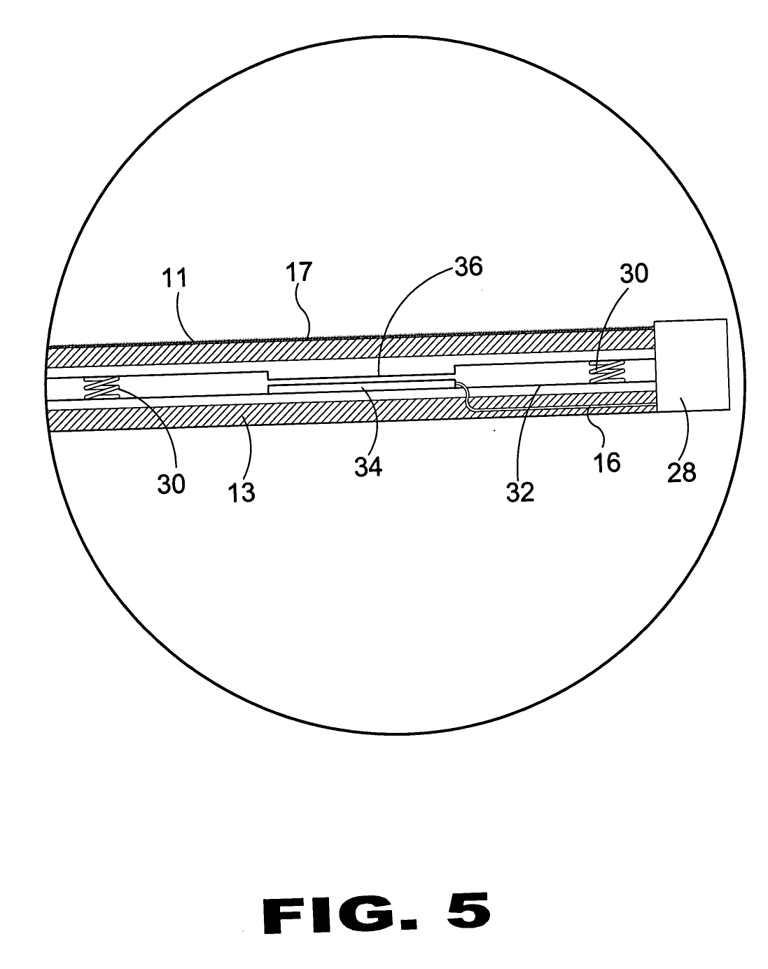

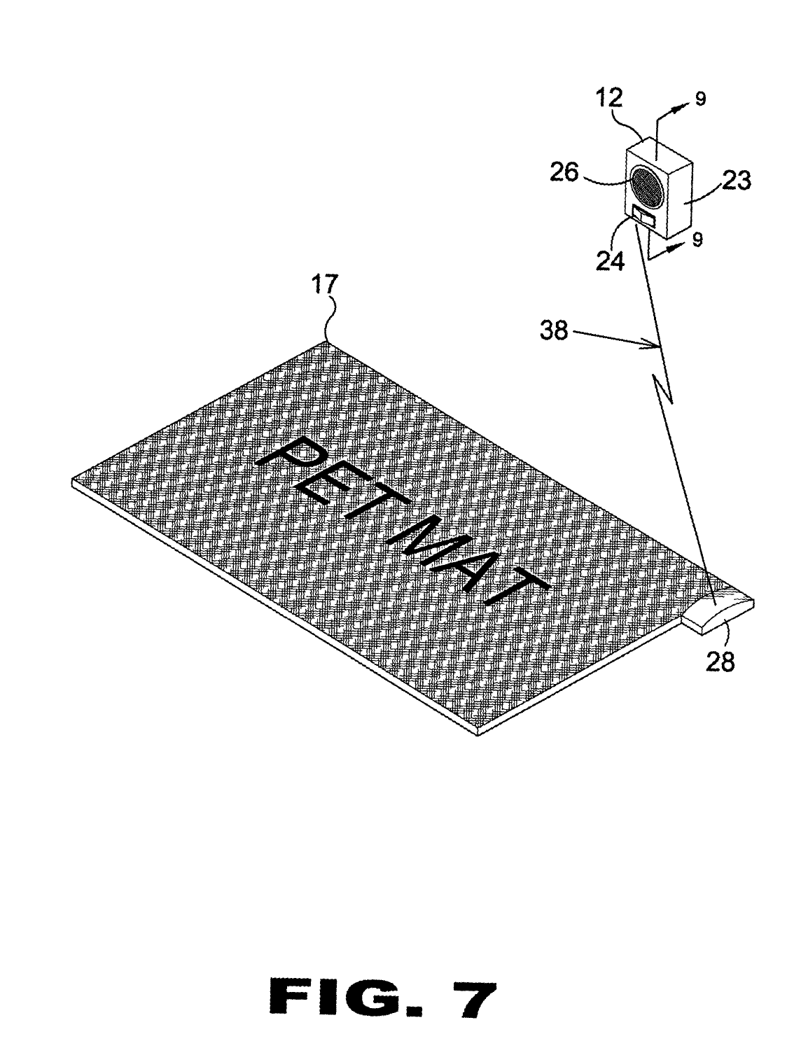

FIG. 1 is an illustrative view of the pressure sensitive apparatus of the present invention in use outside of a house. The pressure sensitive apparatus 10 of the present invention includes a mat 17 and a speaker box 12. The mat 17 is connected to the speaker box 12 via a connection wire 16. Alternatively, the mat 17 can be connected to the speaker box 12 via a wireless transmitter 28 as shown in FIG. 7. The mat 17 is pressure sensitive and upon a predetermined amount of pressure being applied thereto a signal is caused to be transmitted to the speaker box 12 to emit a sound. The sound emitted by the speaker box 12 is indicated by the lines identified with the numeral 22. Preferably, the mat 17 is positioned directly in front of a door 20 and within a door frame 18 of a house 19. The connection wire 16 is preferably wired integrally within the door frame 18 thereby allowing the connection wire 16 to be secured safely away from a pet 14 waiting outside the door 20. The sound 22 emitted by the speaker box 12 functions to alert those within the house 19 that a person, an object, or their pet 14 is positioned on the mat 17 and thereby exerting at least the predetermined amount of pressure on the mat 17. As shown in FIG. 1, a pet 14 is positioned on the mat 17 of the pressure sensitive apparatus 10 of the present invention. Exertion of pressure upon the mat 17 due to the weight of the pet completes an electrical circuit. The completion of the circuit will be discussed hereinafter with specific reference to FIGS. 5, 6, 12, and 13. Upon completion of the electrical circuit, the mat 17 sends a signal through the connection wire 16 to the speaker box 12. Thereafter, the speaker box emits the sound 22 therefrom and notifies those within the house 19 that the pet 14 is waiting to be let in through the door 20.

The sound 22 emitted from the speaker box 12 is preferably the sound of a dog barking or a cat meowing, thereby corresponding to a specific pet. However, any desired sound that notifies a user of the pressure sensitive apparatus 10 that a pet 14 is waiting to be let into or out of the house may be used. Additionally, the pet shown in FIGS. 1-13 is a dog, however, the pressure sensitive apparatus 10 of the present invention can be activated by any animal.

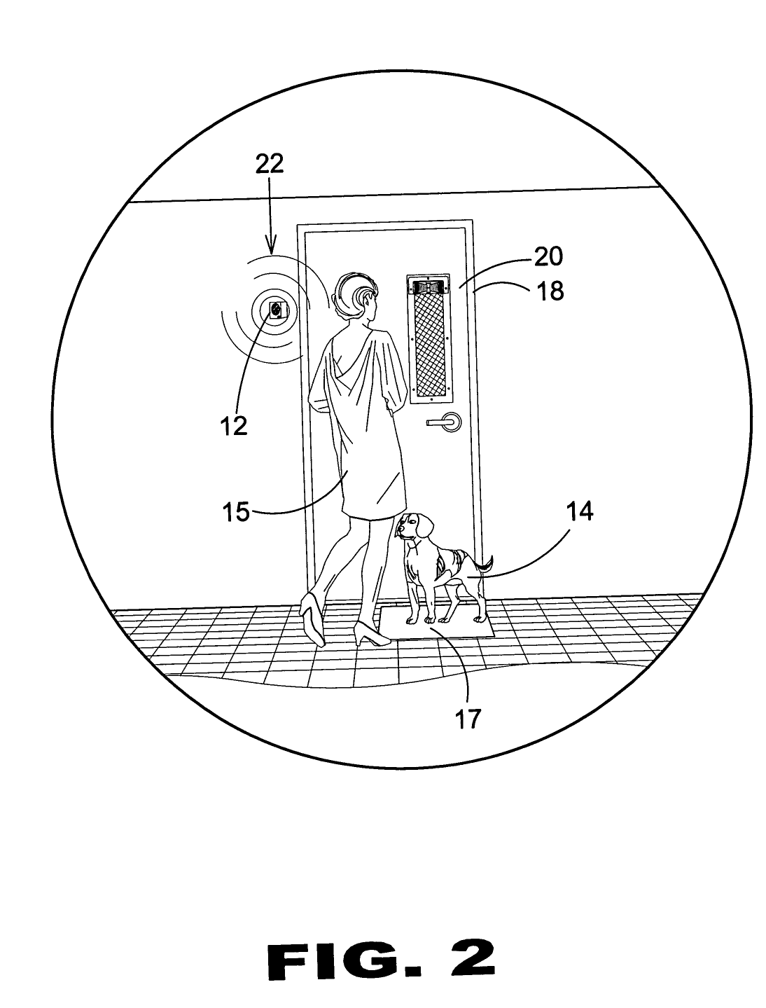

FIG. 2 is an illustrative view of the pressure sensitive apparatus of the present invention in use inside of a house. The pressure sensitive apparatus 10 of the present invention includes the mat 17 and the speaker box 12. The mat 17 is connected to the speaker box 12 via the connection wire 16. Alternatively, the mat 17 can be connected to the speaker box 12 via a wireless transmitter 28 as shown in FIG. 7. The mat 17 is pressure sensitive and upon a predetermined amount of pressure being placed thereon, signals the speaker box 12 to emit sound 22. Preferably, the mat 17 is positioned directly in front of the door 20 held in place by the door frame 18 of the house 19. The sound 22 emitted by the speaker box 12 functions to alert those within the house 19 that a person an object or a pet 14 is exerting at least the predetermined amount of pressure to the mat 17 of the pressure sensitive apparatus 10 of the present invention. As shown in FIG. 2, a pet 14 is positioned on the mat 17 of the pressure sensitive apparatus 10 of the present invention. Exertion of pressure upon the mat 17 completes an electrical circuit. The completion of the circuit will be discussed hereinafter with specific reference to FIGS. 5, 6, 12, and 13. Upon completion of the electrical circuit, the mat 17 sends a signal through the connection wire 16 to the speaker box 12. Thereafter, the speaker box emits the sound 22 therefrom and notifies those within the house 19 that the pet 14 is waiting to be let in through the door 20.

FIG. 2 clearly shows the use of the pressure sensitive apparatus 10 of the present invention in use inside of a house. By positioning the pressure sensitive mat 10 within the house, a person 15 is able to be audibly alerted as to when their pet 14 desires to go outside. This is extremely useful in keeping a house clean and neat and free of pet refuse. By responding to the sound 22 emitted from the speaker box 12, a person is able to allow the pet to go out.

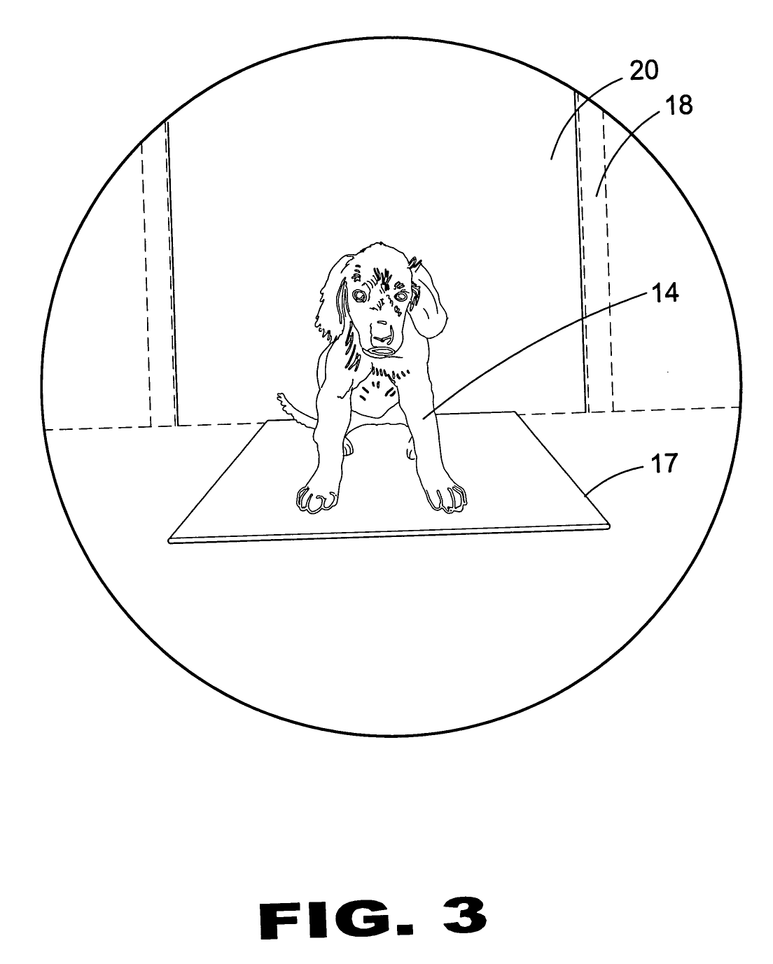

FIG. 3 is an illustrative view of the pressure sensitive apparatus of the present invention with a pet positioned thereon. The mat 17 of the pressure sensitive apparatus 10 of the present invention is shown having the pet 14 positioned thereon. The pressure sensitive apparatus 10 assists in training pets not to go to the bathroom within the house. The pet can be trained to position themselves on the mat 17 thereby causing sound to be emitted alerting the person that the pet needs to either go out or come into the house. The pressure sensitive apparatus 10 of the present invention allows for the person to safely and responsibly train their pets in order to keep his or her house free from pet refuse.

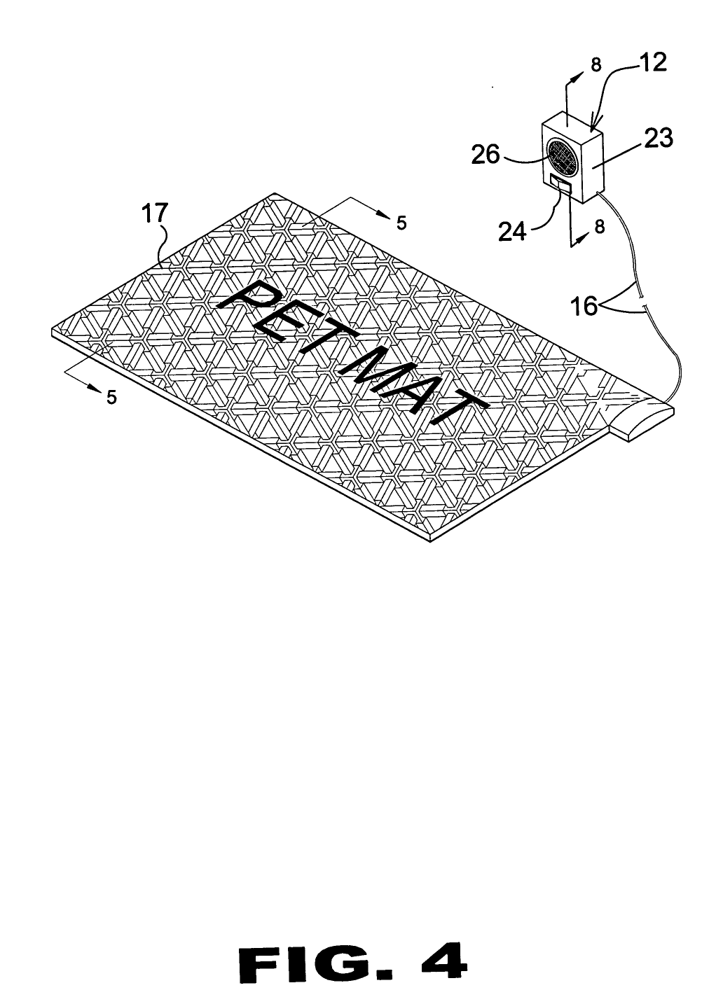

FIG. 4 is a perspective view of the pressure sensitive apparatus of the present invention having a hardwire connection between the mat and the speaker box. The pressure sensitive apparatus 10 of the present invention includes the mat 17 and the speaker box 12. The speaker box 12 includes a housing 23, a power switch 24, and a speaker 26. The mat 17 is connected to the speaker box 12 via the connection wire 16. Alternatively, the mat 17 can be connected to the speaker box 12 via a wireless connection between a transmitter 28 and a receiver 25 as shown in FIG. 7. The mat 17 is pressure sensitive. Upon a predetermined amount of pressure or weight being placed thereon, the mat 17 signals the speaker box 12 to emit sound from the speaker 26. Preferably, the mat 17 is positioned on one side of the door 20 of the house 19 as shown in FIGS. 1-3. The sound 22 emitted by the speaker 26 of the speaker box 12 functions to alert those within the house 19 that a person an object or a pet is exerting at least the predetermined amount of pressure to the mat 17. Exertion of pressure or positioning of a weighted object upon the mat 17 causes the to player of the mat to be depressed thereby completing an electrical circuit. The completion of the circuit will be discussed hereinafter with specific reference to FIGS. 5, 6, 12, and 13. Upon completion of the electrical circuit, the mat 17 sends a signal through the connection wire 16 to the speaker box 12. Thereafter, the speaker 26 of the speaker box 12 emits the sound 22 therefrom and notifies those within the house 19 that the pet 14 is waiting to be let in through the door 20. The power switch 24 allows the person to selectively enable and disable the speaker box 12 from emitting sounds from the speaker 26. This is particularly useful during the nighttime hours when people in the house may be asleep and do not want to be audibly alerted to the desires of their pets to be let into or out of the house or altered to neighborhood animals walking in close proximity to the house 19. Additionally, the pressure sensitive mat 10 can be deactivated when its user is not at home thereby preventing a pet generated recurring sound, which might draw attention to the unoccupied state of the house.

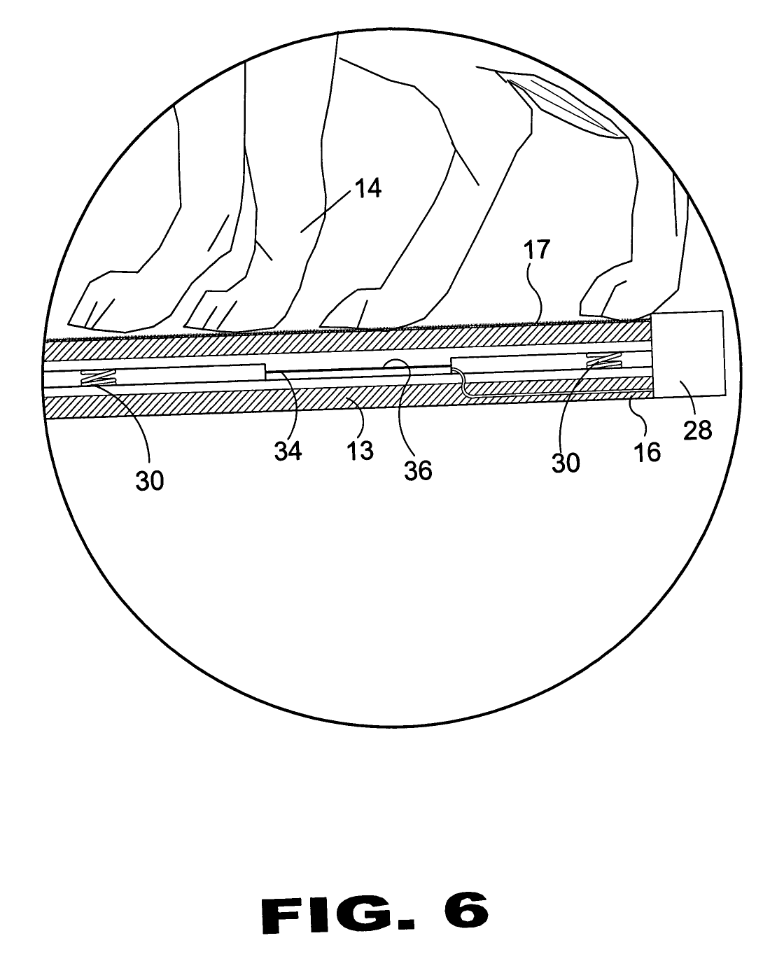

FIG. 5 is a cross-sectional view of the pressure sensitive apparatus of the present invention shown in an uncompressed and inactive state taken along the line 5-5 in FIG. 4. The mat 17 includes a first side 11 and a second side 13. Positioned adjacent to the first side 11 and between the first side 11 and second side 13 is a first contact plate 36. Positioned adjacent to the second side 13 and between the first side 11 and second side 13 is a second contact plate 34. Positioned between the first contact plate 36 and the second contact plate 34 is at least one compression spring 30. Preferably, a plurality of compression springs 30 are positioned between the first contact plate 36 and the second contact plate 34. In their uncompressed form, the compression springs 30 are used to keep the first contact plate 36 from contacting the second contact plate 34 until the predetermined amount of pressure is placed on at least one of the first side 11 and the second side 13 of the mat 17. A predetermined amount of pressure forces the compression springs 30 to compress, thereby causing the first contact plate 36 to contact the second contact plate 34. Compression of the springs 30 is clearly shown in FIG. 6. Upon contact of the first contact plate 36 and the second contact plate 34, an electrical circuit is completed. Thereafter, a signal is sent through the connection wire 16 to the speaker box which signals the speaker box to emit sounds thereby notifying the person that their pet desires to be let in or let out of the house.

FIG. 6 is a sectional view of the pressure sensitive apparatus of the present invention shown in a compressed and active state. The mat 17 includes a first side 11 and a second side 13. Positioned adjacent to the first side 11 and between the first side 11 and second side 13 is the first contact plate 36. Positioned adjacent to the second side 13 and between the first side 11 and second side 13 is the second contact plate 34. Positioned between the first contact plate 36 and the second contact plate 34 is the at least one compression spring 30. Preferably, a plurality of compression springs 30 are positioned between the first contact plate 36 and the second contact plate 34. The compression springs 30 are used to keep the first contact plate 36 from contacting the second contact plate 34, as shown in FIG. 5, until the predetermined amount of pressure is placed on at least one of the first side 11 and the second side 13 of the mat 17. Upon receiving at least the predetermined amount of pressure, the bias force of the spring is overcome and the compression springs 30 are caused to compressed thereby causing the first contact plate 36 to contact the second contact plate 34. Upon contact of the first contact plate 36 and the second contact plate 34, an electrical circuit is completed. Thereafter, a signal is sent through the connection wire 16 to the speaker box which signals the speaker box to emit sounds thereby notifying the person that their pet desires to be let in or let out of the house.

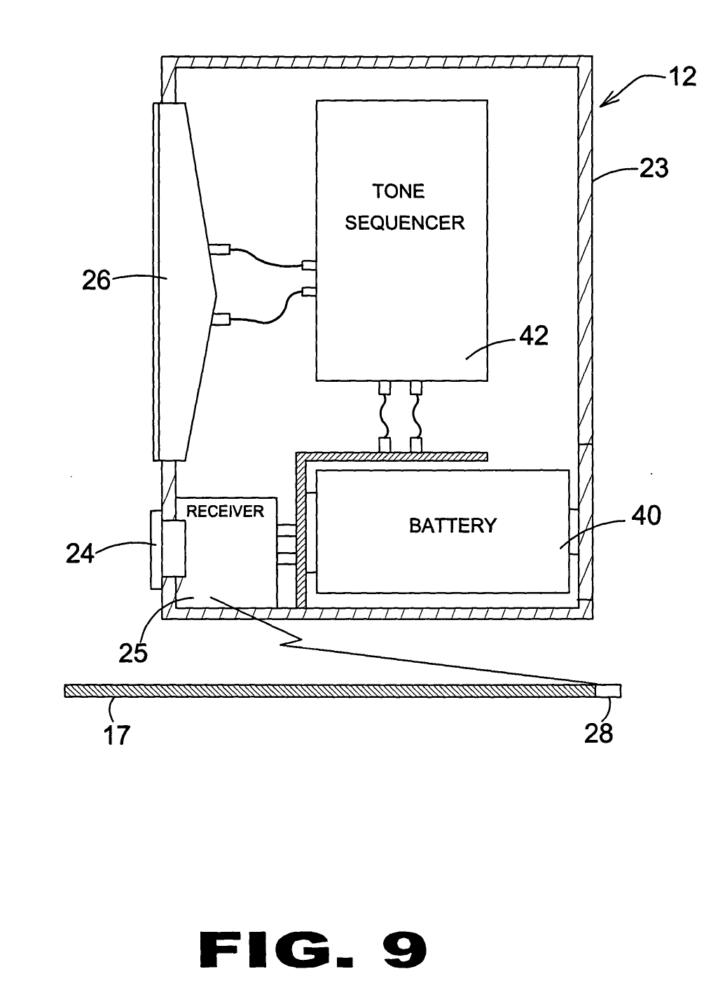

FIG. 7 is a perspective view of the pressure sensitive apparatus of the present invention showing a wireless connection between the mat and the speaker box. The pressure sensitive apparatus 10 of the present invention includes the mat 17 and the speaker box 12. The speaker box 12 has a housing 23. Contained within the housing 23 of the speaker box 12 is a power switch 24, a wireless signal receiver 25 as shown in FIG. 9, and a speaker 26. The mat 17 includes a wireless transmitter 28. The wireless transmitter 28 allows the mat 17 to communicate with the speaker box 12. Alternatively, the mat 17 is connected to and communicates with the speaker box 12 via the connection wire 16 as shown in FIG. 4. The mat 17 is pressure sensitive and upon a predetermined amount of pressure being placed thereon, the mat 17 signals the speaker box 12 via a wireless signal 38 which is received by the receiver 25 of the speaker box 12 to emit sound from the speaker 26. Preferably, the mat 17 is positioned directly in front of the door 20 of the house as shown in FIGS. 1-3. The sound 22 emitted by the speaker 26 of the speaker box 12 alerts a person within the house that a person or a pet is exerting at least the predetermined amount of pressure the mat 17.

Upon exerting pressure upon the mat 17, an electrical circuit is completed. The completion of the circuit is discussed with specific reference to FIGS. 5 and 6 and 12 and 13. Upon completion of the electrical circuit, the mat 17 signals the transmitter 28 to emit a wireless signal 38. The wireless signal 38 is received by the receiver 25 of the speaker box 12. Thereafter, the speaker 26 of the speaker box 12 is caused to emit a sound 22 therefrom and notifies a person that the pet 14 is waiting at the door 20. The power switch 24 allows the person to selectively enable and disable the speaker box 12 from emitting sounds from the speaker 26. This is particularly useful during the nighttime hours when people in the house may be asleep and do not want to be audibly alerted to the desires of their respective pets to be let into or out of the house. Additionally, pressure sensitive mat 10 of the present invention can be deactivated when the person is not at home thereby preventing a recurring sound which might draw attention to the unoccupied state of the house.

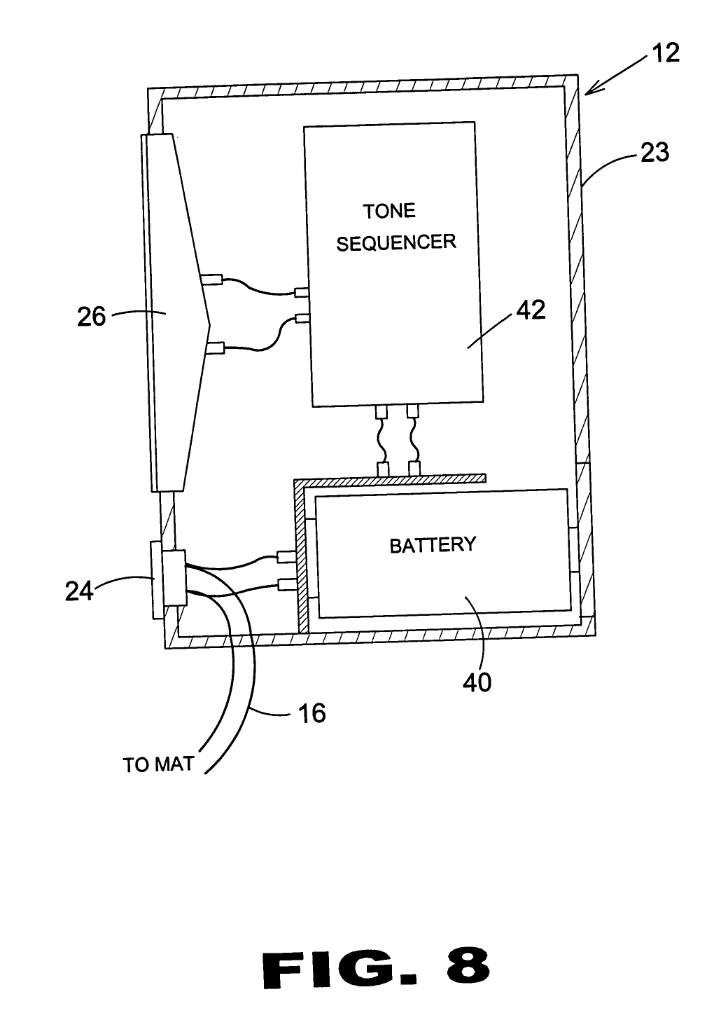

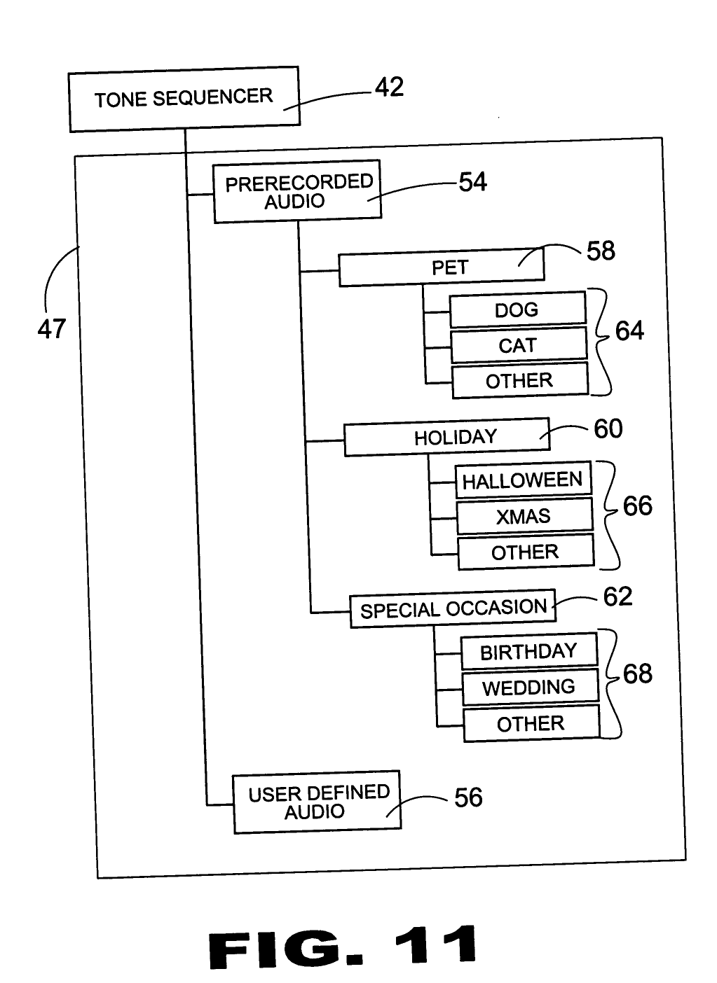

FIG. 8 is a cross-sectional view of the speaker box 12 of the pressure sensitive apparatus 10 of the present invention taken along line 8-8 in FIG. 4. The speaker box 12 includes the housing 23, the speaker 26, and the power switch 24. Contained within the housing 23 of the speaker box 12 is a power source 40 and a tone sequencer 42. The tone sequencer 42 is connected to the power source 40 and the speaker 26. The tone sequencer 42 controls the style of sound which is emitted by the speaker 26 upon completion of the electrical circuit in the pressure sensitive apparatus of the present invention. The tone sequencer 42 will be discussed hereinafter with specific reference to FIG. 11. The power switch 24 is connected to the mat 17 and the power source 40 to allow the mat 17 to be uncoupled from the source 40. The connection wire 16 connects the mat 17 to the power switch 24. When the power switch 24 is in a first closed position, current can freely pass from the power source 40 through the mat 17 and if the mat 17 is stepped upon, to the tone sequencer 42. When the power switch is in a second open position, the current from the power source 40 cannot flow therefrom.

When the power switch 24 is in the first closed position and the first and second contact plates, 36 and 34, respectively, are in contact with one another as shown in FIG. 6, the electrical circuit is completed allowing electrical current to flow. Power flows from the power source 40 through the connection wire 16 and to the first contact plate 36. The current then flows from the first contact plate 36 to the second contact plate 34 through the connection wire 16 powering the tone sequencer 42, thereby causing sound 22 to be emitted from the speaker 26. When the first contact plate 36 is disconnected from the second contact plate 34, the circuit is disrupted and no sound is produced by the speaker 26.

FIG. 9 is a cross-sectional view of the speaker box of the pressure sensitive door mat of the present invention taken along line 9-9 in FIG. 7. The speaker box 12 includes the housing 23, the speaker 26, and the power switch 24. Contained within the housing 23 of the speaker box 12 is a power source 40 and a tone sequencer 42. The tone sequencer 42 is connected to the power source 40 and the speaker 26. The tone sequencer 42 controls the style of sound which is emitted by the speaker 26 upon completion of the electrical circuit in the pressure sensitive apparatus of the present invention. The tone sequencer 42 will be discussed hereinafter with specific reference to FIG. 11. The power switch 24 is connected to the receiver 25 and provides power thereto. The receiver 25 is able to receive a wireless signal emitted from the wireless transmitter 28 as shown in FIG. 7. Also connected to the receiver 25 is the power source 40. When the power switch 24 is in a first closed position, current can freely pass from the power source 40 to the receiver 25 and then enables the receiver 25 to receive wireless signals 38. When the power switch is in a second open position, the current from the power source 40 cannot flow therefrom and the receiver 25 is not able to receive wireless signals 38.

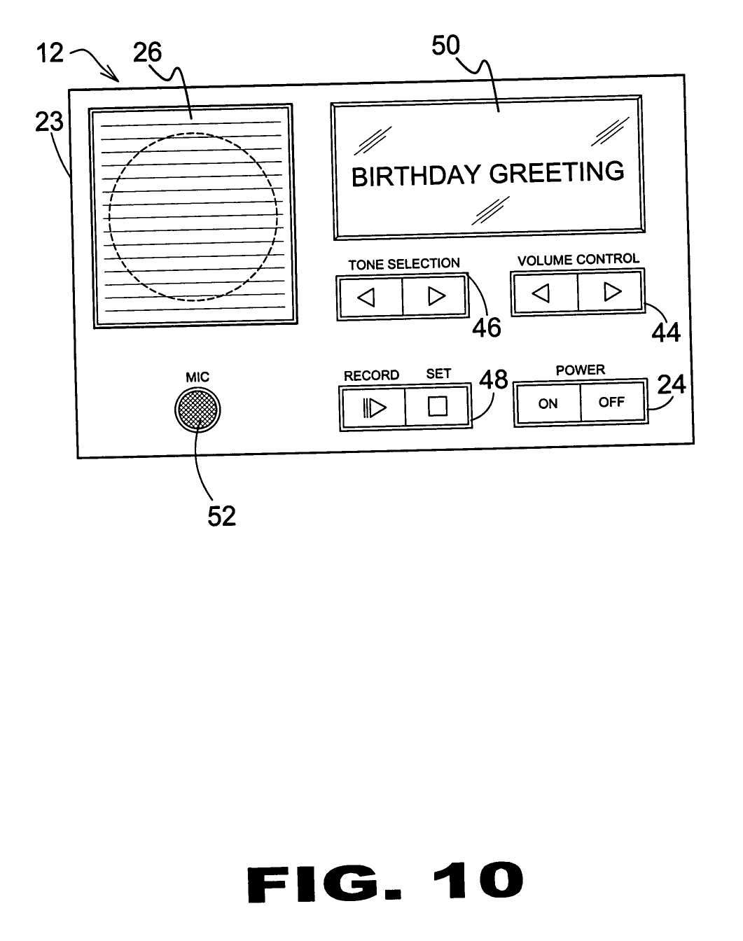

FIG. 10 is a front view of the speaker box of the pressure sensitive door mat 10 of the present invention. The speaker box 12 as shown in FIG. 10 includes additional features which can be used with the pressure sensitive apparatus 10 of the present invention. Along with the power switch 24 and the speaker 26, the speaker box 12 includes a volume control 44, a tone selection control 46, personalization controls 48, a display screen 50, and a microphone 52.

The tone control buttons 46 allow the person to selectively determine the sounds 22 to be emitted by the tone sequencer 42 as shown in FIGS. 8 and 9. The number and styles of tones contained within the tone sequencer 42 will be discussed hereinafter with specific reference to FIG. 11. The tone control buttons 46 allow a user to scroll serially through the stored list of tones contained within the tone sequencer 42 until the desired tone to be played upon activation of the pressure sensitive apparatus 10 of the present invention has been reached. Upon selecting the desired tone, the identifying name or title associated with the tone to be played is displayed on the display screen 50. Alternatively, the display screen 50 can display information lists stored in a tone sequencer memory 47 about specific events, such as birthdays or anniversary's. The tone sequencer memory 47 will be discussed hereinafter with specific reference to FIG. 11.

The personalization controls 48 enable a person to selectively record their own tones or greetings to be played through the speaker 26 of the speaker box 12. The personalization controls also enable the person to selectively enter a description of a specific event which the person would like to display on the display screen 50. Upon activating the personalization controls, the person is able to speak or play music in the vicinity of the microphone 52. A recorder inside the tone sequencer 42 records the voice or music. The person is then able to assign a name and include the newly recorded sounds to be part of the pre-stored tones of the tone sequencer 42.

The volume control buttons 44 allow the user to selectively raise and/or lower the volume at which the sound is emitted from the speaker 26. The volume control 44 controls the volumes of the sounds selected using the tone selection buttons 46 as well as the sounds personalized using the personalization control buttons.

FIG. 11 is a block diagram showing the tone sequencer 42 connected to the memory 47 of the pressure sensitive apparatus 10 of the present invention. As can be seen from this figure, the tone sequencer 42 is connected to a memory unit 47. The memory unit 47 is preferably able to retain pre-stored tones 54 and user defined tones 56. The memory unit 47 is able to store a finite number of user defined tones 56. The number and types of pre-stored tones 54 are selectively programmable upon manufacture of the tone sequencer 42. As shown in FIG. 11, the memory unit 47 has a first category of pre-stored tones 58 which includes a first set of pre-stored tones 64. The memory unit 47 also includes a second category of pre-stored tones 60 which includes a second set of tones 66 and a third category of pre-stored tones 62 which includes a third set of tones 68. The memory unit 47 is described as having three categories of tones, each with their own set of tones for purposes of example only. The memory unit 47 is able to contain any desired number of tone categories each having any desired number on tones contained therein.

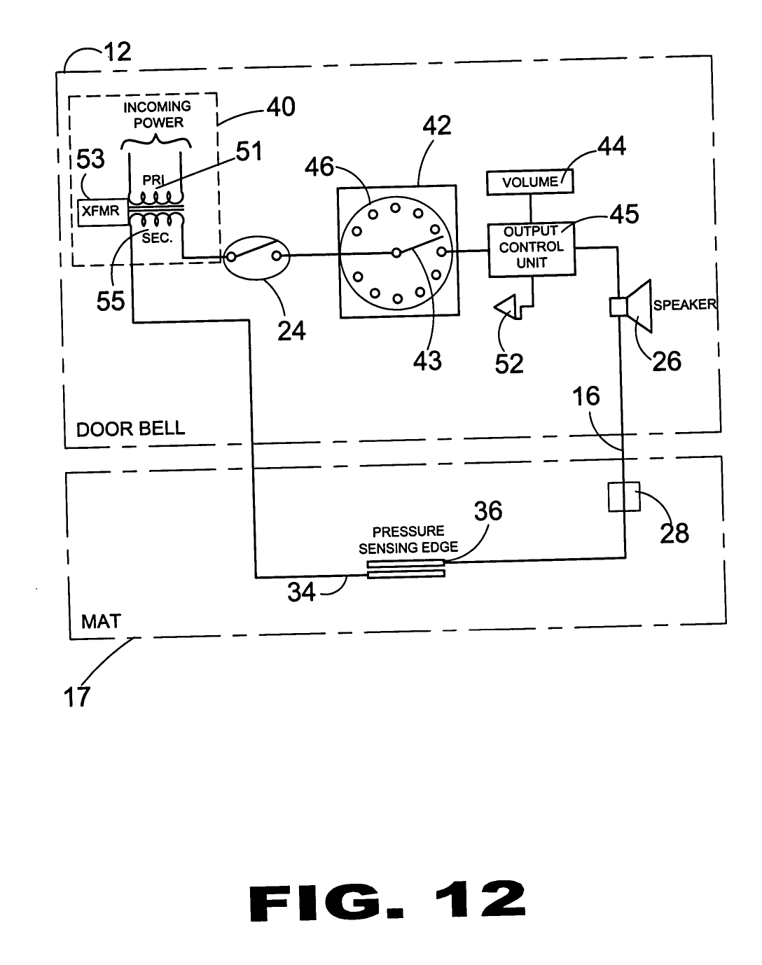

FIG. 12 is an electrical diagram of the pressure sensitive door mat of the present invention having a hardwired connection between the mat and the speaker box. The speaker box 12 includes the power source 40, the power switch 24, the tone sequencer 42, an output control unit 45, the volume control buttons 44, the microphone 52, and the speaker 26. The mat 17 includes the first contact plate 36 and the second contact plate 34. The mat 17 is connected to the speaker box 12 via the connection wires 16.

The power switch 24 must be moved into the first closed position thereby allowing current to flow from the power source 40. Thereafter and upon pressure being applied to the mat 17, the first contact plate 36 contacts the second contact plate 34. The contact of the first plate 36 with the second plate 34, causes a second switch, positioned within the tone sequencer 42, to be moved from an open to a closed position thereby closing the circuit and causing the tone selected by the tone selection button 46 to be selected. A transformer 53 coupled to a primary power source 51 transforms the voltage the primary power source 51 to a lower voltage to provide power to the pressure sensitive apparatus 10 of the present invention.

Upon power being provided, the tone sequencer 42 generates the tone, which is selected using the tone control buttons 46, and provided to the output control unit 45. The volume of the output control unit 45 is selectively controllable by the volume buttons 44. Thereafter, the output control unit 45 signals the speaker to emit the tone selected by the tone sequencer 42 at the volume selected using the volume buttons 44. The tone is thus emitted from the speaker 26 and thereby alerts the person in the house that a pet is waiting to be let into the house or is ready to go out of the house.

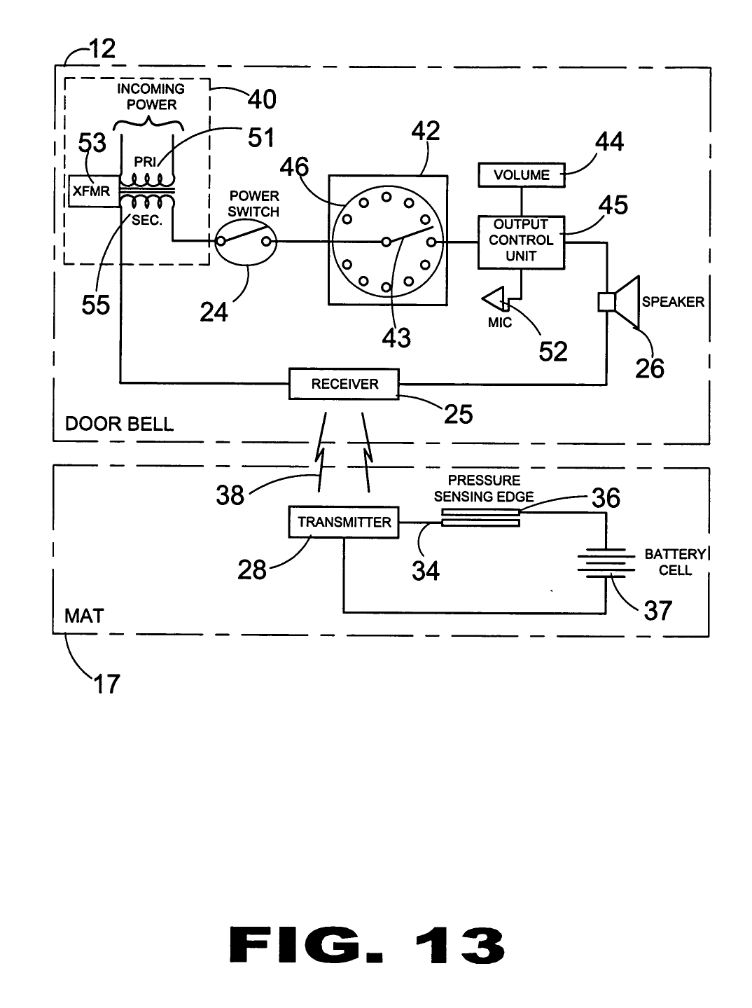

FIG. 13 is an electrical diagram of the pressure sensitive door mat of the present invention having a wireless connection between the mat 17 and the speaker box 12. The speaker box 12 includes the power source 40, the power switch 24, the tone sequencer 42, an output control unit 45, the volume control buttons 44, the microphone 52, and the speaker 26. The mat 17 includes the first contact plate 36, the second contact plate 34, the transmitter 28, and a power cell 37. The mat 17 communicates with the speaker box 12 via a wireless signal 38.

The power switch 24 must be in the first closed position thereby allowing power to flow from the power source 40. Thereafter and upon pressure being applied to the mat 17, the first contact plate 36 contacts the second contact plate 34. The contact of the first plate 36 with the second plate 34, controls the transmitter 28 to transmit the wireless signal 38 to the speaker box 12. Upon receipt of the wireless signal 38, the second switch 43, positioned within the tone sequencer 42, is caused to moved into the first closed position thereby providing power to the tone sequencer 42. Thereafter and upon pressure being applied to the mat 17, the first contact plate 36 contacts the second contact plate 34. The contact of the first plate 36 with the second plate 34, causes a second switch 43, positioned within the tone sequencer 42, to be moved from an open to a closed position thereby closing the circuit causing the tone selected by the tone selection button 46 to be selected. A transformer 53 coupled to a primary power source 51 transforms the voltage the primary power source 51 to a lower voltage to provide power to the pressure sensitive apparatus 10 of the present invention.

Upon power being provided, the tone sequencer 42 provides the tone, which is selected using the tone control buttons 46, to the output control unit 45. The volume of the output control unit 45 is selectively controllable by the volume buttons 44. Thereafter, the output control unit 45 signals the speaker to emit the tone selected by the tone sequencer 42 at the volume selected using the volume buttons 44. The tone is thus emitted from the speaker 26 and thereby alerts the person in the house that a pet is waiting to be let into the house or is ready to go out of the house.

From the above description it can be seen that the pressure sensitive doormat of the present invention is able to overcome the shortcomings of prior art devices by providing a pressure sensitive doormat that is able to selectively determine when a pet is positioned on a mat by audibly alerting a person that the pet is waiting to be let in to or out from the house.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A pressure sensitive apparatus comprising:
a) a mat having a first contact plate, a second contact plate, and a compression spring positioned between said first and second contact plates thereby creating a space between said first and second contact plates;
b) a speaker box including a speaker and a power source connected to said speaker; and
c) means for connecting said power source to said speaker through said mat, wherein upon applying a pre-determined amount of pressure on said mat, overcomes a bias force of said compression spring causing said compression spring to be compressed thereby causing said first contact plate and said second contact plate to contact one another completing an electrical circuit between said power source and said speaker and causing an audible sound to be emitted from said speaker.

2. The pressure sensitive apparatus as recited in claim 1, wherein said mat includes a first side and a second side, said first and second contact plates being positioned between said first and second sides of said mat.

3. The pressure sensitive apparatus as recited in claim 1, wherein said connecting means is a wire.

4. The pressure sensitive apparatus as recited in claim 1, wherein said connecting means is a wireless connection, said wireless connection comprising:
a) a transmitter positioned within said mat; and
b) a receiver positioned within said speaker box, wherein upon said first contact plate contacting said second contact plate, said transmitter transmits a wireless signal for receipt by said receiver, wherein upon receipt of said wireless signal, said speaker emits an audible sound.

5. The pressure sensitive apparatus as recited in claim 1, wherein said speaker box further comprises a tone sequencer connected to said speaker for creating and selecting audible sounds to be emitted by said speaker.

6. The pressure sensitive apparatus as recited in claim 5, wherein said tone sequencer includes a memory unit for storing data indicative of audible sounds, wherein said memory unit is selectively programmable to include at least one of pre-stored sounds and user defined sounds.

7. The pressure sensitive apparatus as recited in claim 1, wherein said speaker box further includes a power switch for selectively providing power to said apparatus.

8. The pressure sensitive apparatus as recited in claim 6, wherein said speaker box includes tone selection buttons for selecting a respective one of said sounds stored in said memory unit.

9. The pressure sensitive apparatus as recited in claim 6, wherein said speaker box further comprises recording means and personalization controls for selectively creating and storing said user defined sounds in said memory unit.

10. The pressure sensitive apparatus as recited in claim 9, wherein said speaker box further comprises a display screen for selectively displaying information stored in aid memory unit, said information being at least one of a name of said sound, a special occasion, and user defined information.

11. A method for sounding an audible alert said method comprising the steps of:
a) exerting a predetermined amount of pressure on a pressure sensitive mat, able to overcome a bias force of a spefing causing first and second contact plates within the mat to come into contact and thereby close a circuit;
b) signaling to a speaker connected to one of said first and second contact plates upon closing the circuit to audiblize; and
c) emitting an audible sound from a speaker positioned on said speaker box.

12. A pressure sensitive apparatus for audibly alerting a person to the presence of a person or animal at a door, said pressure sensitive apparatus comprising:
a) a mat having a first contact plate, a second contact plate, and a compression spring positioned between said first and second contact plates thereby creating a space between said first and second contact plates;
b) a speaker box including a speaker, a tone sequencer, and a power source connected to said speaker and said tone sequencer; and
c) a wireless transmitter comprising a wireless transmitter and a power source positioned within said mat and a wireless receiver positioned within said speaker box, wherein upon applying a pre-determined amount of pressure on said mat, overcomes a bias force of said compression spring causing said compression spring to be compressed thereby causing said first contact plate and said second contact plate to contact one another completing an electrical circuit between said power source and said wireless transmitter, said wireless transmitter transmits a wireless signal for receipt by said wireless receiver which causes said tone sequencer to emit a sound through said speaker.
